(19) United States
(12) Patent Application Publication
(10) Pub. No.: US 2025/0371675 A1
(43) Pub. Date: Dec. 4, 2025

(54) BLIND FACE RESTORATION WITH CONSTRAINED GENERATIVE PRIOR

(71) Applicant: ADOBE INC., SAN JOSE, CA (US)

(72) Inventors: Zheng Ding, La Jolla, CA (US); Xuaner Zhang, Union City, CA (US); Zhihao Xia, Sunnyvale, CA (US)

(21) Appl. No.: 18/678,221

(22) Filed: May 30, 2024

(51) Int. Cl. G06T 5/60; G06T 5/50; G06T 5/70

(52) U.S. Cl. CPC G06T 5/60; G06T 5/50; G06T 5/70; G06T 2207/20081; G06T 2207/20084

(57) ABSTRACT

A method, apparatus, non-transitory computer readable medium, and system for image processing include obtaining an input image depicting an entity and having a first quality level, adding noise to the input image based on the first quality level to obtain an intermediate noise image, and generating a restored image depicting the entity by denoising the intermediate noise image, where the restored image has a second quality level higher than the first quality level.

### BACKGROUND

The following relates generally to image processing, and more specifically to image processing using a machine learning model. Image processing refers to the use of a computer to edit an image using an algorithm or a processing network. In some cases, image processing software can be used for various image processing tasks such as image detection, image compositing, image editing, image generation, and image restoration. For example, image restoration includes the use of the machine learning model to improve the quality of a degraded image such as a blurry image, a distorted image, or a pixelated image.

In some cases, the machine learning model enhances the visual appearance of an input image by reducing noise, removing artifacts, and recovering visual details. In some cases, the machine learning model generates a high-quality image based on a low-quality image input. However, in some cases desirable visual features from the input image are not maintained during the processing.

### SUMMARY

Aspects of the present disclosure provide a method and a system for image restoration. According to some aspects, the system includes an image generation model trained to generate a high-quality image (or a restored image) based on a low-quality input image. In some cases, visual features from the low-quality input image are maintained in the restored image. In one aspect, the image generation model is fine-tuned based on a real image of an entity depicted in the input image. In one aspect, the image generation model is fine-tuned based on a synthetic image generated using a skip guidance method. In one aspect, a generative space of the image generation model is constrained based on the real image or the synthetic image.

A method, apparatus, non-transitory computer readable medium, and system for image processing include obtaining an input image depicting an entity and having a first quality level, adding noise to the input image based on the first quality level to obtain an intermediate noise image, and generating, using an image generation model, a restored image depicting the entity by denoising the intermediate noise image, where the restored image has a second quality level higher than the first quality level.

A method, apparatus, non-transitory computer readable medium, and system for image processing include obtaining a training set including a training image depicting an entity, generating a noisy image and guidance information based on the training image, and training an image generation model to generate a restored image depicting the entity based on an input image depicting the entity, where the image generation model is trained using the noisy image, the training image, and the guidance information.

An apparatus and system for image processing include at least one processor, at least one memory storing instructions executable by the at least one processor, and an image generation model comprising parameters stored in the at least one memory and trained to generate a restored image based on an input image depicting an entity, wherein the input image is combined with a noise input to obtain a noisy image, wherein the restored image is generated based on the noisy image, and wherein the image generation model is trained using a training image depicting the entity.

### BRIEF DESCRIPTION OF THE DRAWINGS

FIG. 1 shows an example of an image processing system according to aspects of the present disclosure.

FIG. 2 shows an example of a method for generating a restored image according to aspects of the present disclosure.

FIG. 3 shows an example of single-image restoration according to aspects of the present disclosure.

FIG. 4 shows an example of image restoration using real images according to aspects of the present disclosure.

FIG. 5 shows an example of a method for generating a restored image based on an input image according to aspects of the present disclosure.

FIG. 6 shows an example of an image processing apparatus according to aspects of the present disclosure.

FIG. 7 shows an example of a machine learning model according to aspects of the present disclosure.

FIG. 8 shows an example of image projection in image restoration according to aspects of the present disclosure.

FIG. 9 shows an example of generative space constraining of an image generation model according to aspects of the present disclosure.

FIG. 10 shows an example of an image generation model according to aspects of the present disclosure.

FIG. 11 shows an example of a method for training an image generation model according to aspects of the present disclosure.

FIG. 12 shows an example of fine-tuning an image generation model according to aspects of the present disclosure.

FIG. 13 shows an example of a method for training an image generation model based on a loss according to aspects of the present disclosure.

FIG. 14 shows an example of a computing device according to aspects of the present disclosure.

### DETAILED DESCRIPTION

Aspects of the present disclosure provide a method and a system for image restoration. According to some aspects, the system includes an image generation model trained to generate a high-quality image (or a restored image) based on a low-quality input image. In some cases, visual features from the low-quality input image are maintained in the restored image. In one aspect, the image generation model is fine-tuned based on a real image of an entity depicted in the input image. In one aspect, the image generation model is fine-tuned based on a synthetic image generated using a skip guidance method. In one aspect, a generative space of the image generation model is constrained based on the real image or the synthetic image.

According to some embodiments, the image generation model preserves an identity or maintains visual features from the input image in the restored image by constraining the generative space of the image generation model. For example, a real image or a synthetic image is used as an anchor image to fine-tune the image generation model. As a result, the path of image generation becomes more constrained towards a sub-region in the generative space constrained by the anchor images. Accordingly, the image generation model can generate the restored image without additional guidance based on the constrained generative space. In addition, a visual feature or an identity of the entity from the input image is preserved in the restored image.

Conventional image generation models are trained on datasets comprising pairs of high-quality and low-quality images. In some cases, the image pairs are synthetically generated, which depicts one or more types of degradations (such as blur, distorted, pixelated, low resolution, etc.). However, conventional image generation models become task-specific models because of the training data. As a result, conventional image generation models fall short when applied to real-world low-quality images that include multiple degradations and/or unknown degradations.

Some conventional image generation models are trained using blind restoration models that simulate various degradation types. For example, some models enhance pre-trained GAN networks with modules to control generative priors for blind face restoration. In some cases, some models utilize the low-dimensional space of facial images to generate restored images. In some cases, a conditional diffusion model is trained for face image restoration by adding low-quality images at different layers of the diffusion model. In some cases, pre-trained diffusion models and face restoration networks are combined. In some cases, additional information presented in a guide image or photo album is incorporated to enhance the restoration result. However, these conventional models rely on synthetic paired data for training, which limits the generalizability of the models.

In some cases, model-based techniques are used to form a posterior of the clean image given the degraded image, with a probability term from the degradation process and an image prior. For example, a conventional technique utilizes a denoising network as the image prior. The image priors are integrated with the known degradation process during inference and Maximum A Posteriori (MAP) problem is addressed through approximate iterative optimization. In some cases, image restoration is achieved using GAN inversion, where the model identifies a latent code that generates an image closely matching the input image after processing the input image through the known degradation. In some cases, unsupervised posterior sampling technique using a pre-trained denoising diffusion model is used to solve linear inverse problems. However, these conventional techniques generally assume that the degradation process is known at inference time, which limits the practicability of synthetic evaluations.

In some cases, personalization methods adapt pre-trained diffusion models to specific subjects or concepts. For example, in text-to-image synthesis, customization can be achieved through fine-tuning with personalized data, adapting token embeddings of visual concepts, fine-tuning the whole denoising network, or a subset of the network. In some cases, bypassing per-object optimization is used by training an encoder to extract embeddings of the subject identity and injecting the embeddings into the diffusion model's sampling process. In some cases, personalized facial editing is achieved by fine-tuning a 3D-aware diffusion model on a personal album.

Accordingly, the present disclosure describes a method and a system that generates a high-quality restored image having enhanced visual appearance of image features of a low-quality input image. In one aspect, the image generation model generates the restored image based on an input image depicting an entity. In some cases, the input image is combined with noise to obtain a noisy image. The noisy image is used to initiate a diffusion process of the image generation model to generate the restored image. By initiating the diffusion process from a noisy image (instead of pure noise), the processing time is reduced and thus the computational efficiency is increased. In addition, by initiating the diffusion process from the noisy image rather than pure noise, the visual features of the input image can be maintained in the restored image.

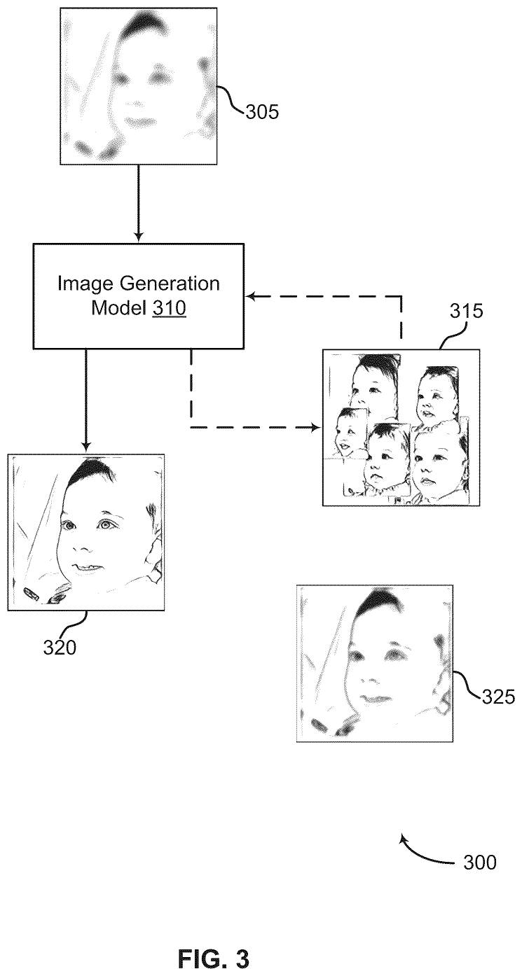

According to some embodiments, the image generation model generates the restored image without using the input image or another image as guidance. In some cases, a conventional model uses the input image as guidance in the diffusion process to generate a restored image. However, for example, as shown in at least FIG. 3, the conventional restored image still retains low-quality features of the input image, such as fuzzy edges and unclear detail. Accordingly, by constraining the generative space of the image generation model, the generation model can generate a restored image that follows the information in the input image while maintaining the high image quality.

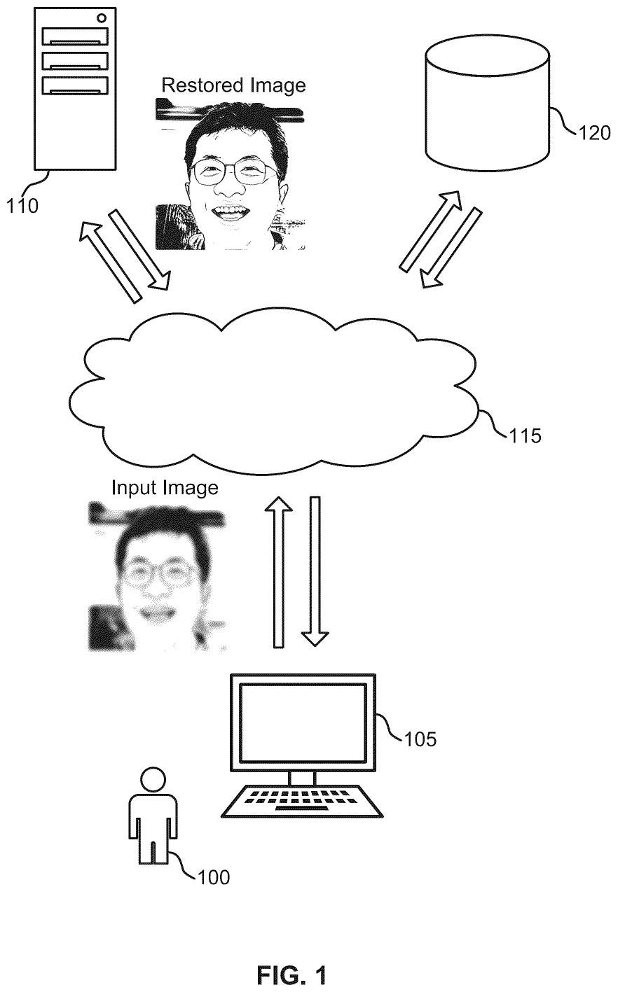

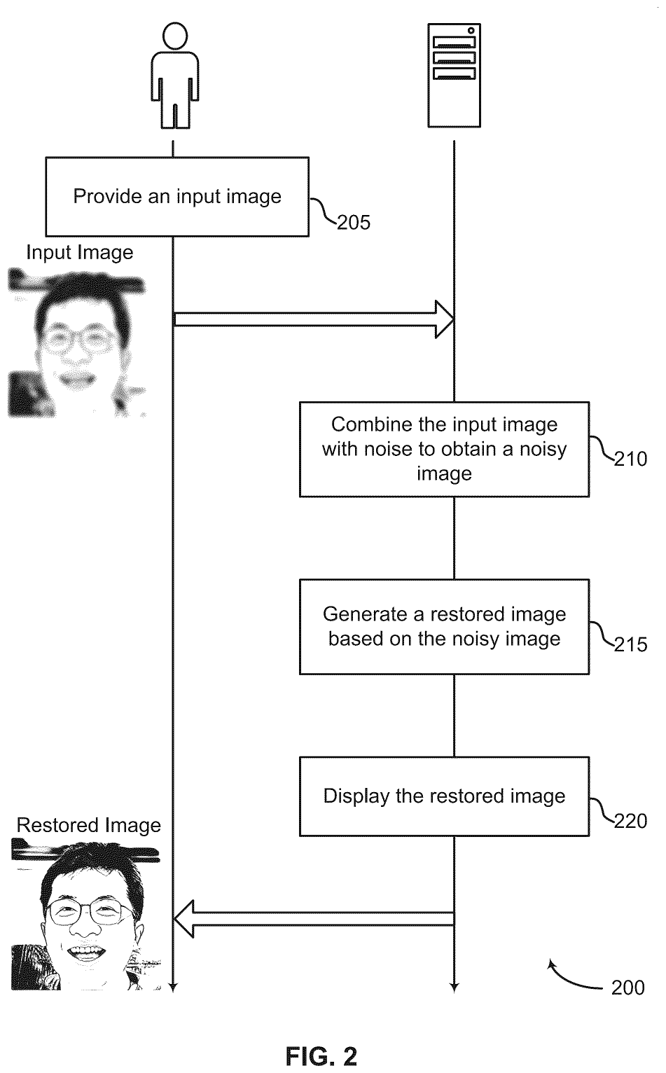

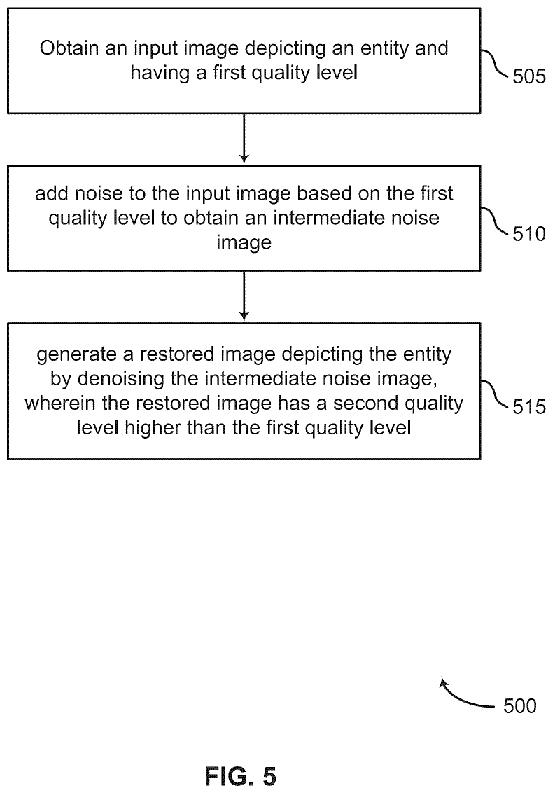

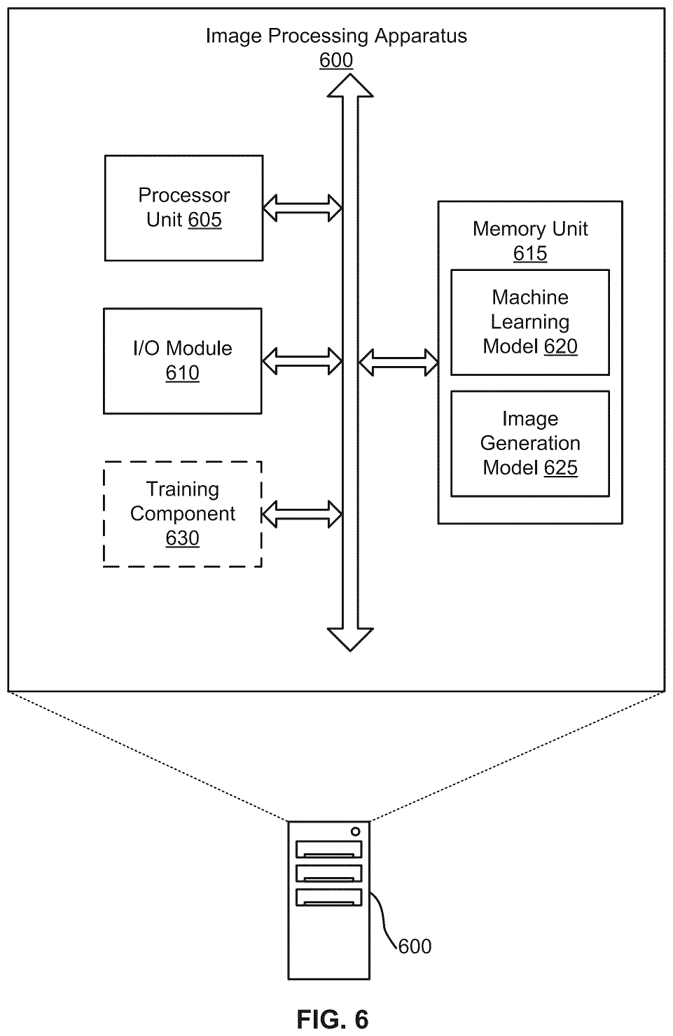

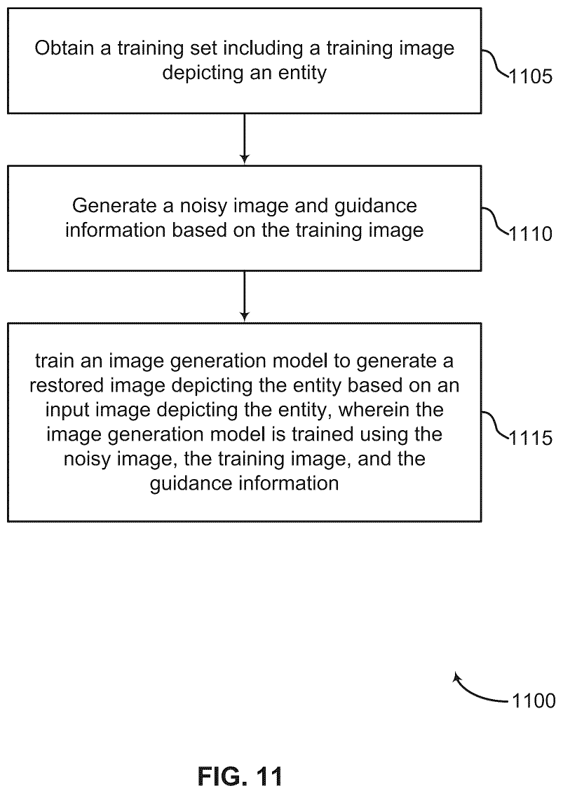

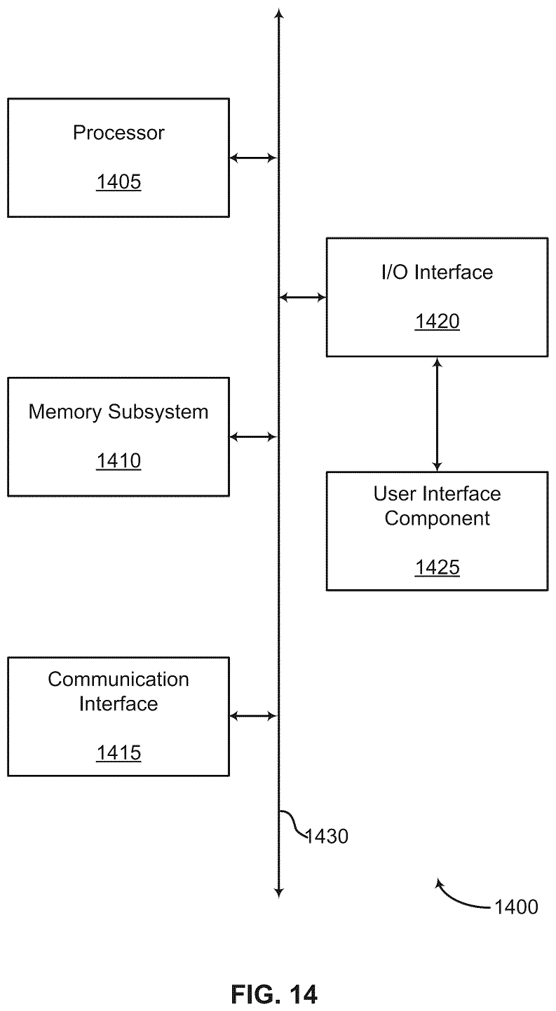

An example system of the inventive concept in image processing is provided with reference to FIGS. 1 and 14. An example application of the inventive concept in image processing is provided with reference to FIGS. 2-4. Details regarding the architecture of an image processing apparatus are provided with reference to FIGS. 6-10. An example of a process for image processing is provided with reference to FIG. 5. A description of an example training process is provided with reference to FIGS. 11-13.

Embodiments of the present disclosure include systems and methods that improve on conventional image generation models by more accurately and efficiently generating images based on a low-quality input image. For example, the image generation model uses a noisy image (instead of pure noise) to initiate the diffusion process to generate the restored image. As a result, the generation speed can be reduced. In addition, image features from the input image can be maintained in the restored image. In one aspect, the generative space of the image generation model is constrained using one or more real images or one or more synthetic images. Accordingly, image features from the input image are preserved in the restored image. In addition, the restored image can be generated without guidance. Accordingly, the high image quality in the restored image is maintained.

In some embodiments, an image generation model is trained using high-quality images pairs in addition to, or as an alternative to image pairs including both a low-quality image and a high-quality image. Accordingly, the image generation model of the present disclosure is well-generalized even to unknown degradation types.

### Image Restoration

In FIGS. 1-6, a method, apparatus, non-transitory computer readable medium, and system for image processing include obtaining an input image depicting an entity and having a first quality level, adding noise to the input image based on the first quality level to obtain an intermediate noise image, and generating, using an image generation model, a restored image depicting the entity based on the intermediate timestep, the restored image has a second quality level higher than the first quality level.

Some examples of the method, apparatus, non-transitory computer readable medium, and system further include selecting a timestep based on the first quality level, wherein the denoising is performed based on the selected timestep. Some examples of the method, apparatus, non-transitory computer readable medium, and system further include iteratively removing noise from the noisy image based on the selected timestep.

In some aspects, the intermediate timestep is based on a quality of the input image. In some aspects, the image generation model has a constrained latent space based on training using at least one training image depicting the entity. In some aspects, the restored image is generated without providing an image as guidance to an intermediate stage of the image generation model.

Some examples of the method, apparatus, non-transitory computer readable medium, and system further include generating a synthetic image depicting the entity, where the image generation model is trained based on the synthetic image. In some aspects, the restored image preserves an identity of the entity from the input image. In some aspects, the restored image has a higher image quality than the input image.

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 6.

Referring to FIG. 1, user 100 provides an input image to image processing apparatus 110 via user device 105 and cloud 115. For example, the input image is a low-quality image (e.g., a blurry image) depicting a person. In some cases, the input image is a low-quality image depicting a scene, object, entity, etc. In some cases, a low-quality image includes a blurred image, pixelated image, low-resolution image, distorted image, etc. In response, a machine learning model of image processing apparatus 110 generates an output image (sometimes referred as a restored image) having a higher quality than the input image. For example, the output image is a high-quality image depicting the person from the input image. In some cases, a high-quality image includes a sharp image, high-resolution image, etc. In some cases, the restored image depicts the person in a well-defined manner having fine details and edges. In some cases, the identity of the person depicted in the input image is preserved in the restored image.

In some embodiments, user 100 provides additional real images to image processing apparatus 110. In some cases, for example, the additional real images are a set of high-quality real images that depict the person from the input image. Image processing apparatus 110 uses the additional real images to preserve the identity of the person depicted in the restored image. For example, a blurry image of a man named Henry is used as an input image to image processing apparatus 110. In addition, a set of real images of Henry is provided to image processing apparatus 110. By using the set of real images as anchor images, image processing apparatus 110 generates a restored image with well-defined edges and clean details depicting Henry from the blurry image. In some cases, image processing apparatus 110 displays the restored image to user 100 via user device 105 and cloud 115.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may include a graphical user interface (GUI). In some examples, a user interface may be represented in code in which the code is sent to the user device 105 and rendered locally by a browser. The process of using the image processing apparatus 110 is further described with reference to FIG. 2.

Image processing apparatus 110 is an example of, or includes aspects of, the corresponding element described with reference to FIG. 6. According to some aspects, image processing apparatus 110 includes a computer-implemented network comprising a machine learning mode and an image generation model. Image processing apparatus 110 further includes a processor unit, a memory unit, an I/O module, and a training component. In some embodiments, image processing apparatus 110 further includes a communication interface, user interface components, and a bus as described with reference to FIG. 14. Additionally, image processing apparatus 110 communicates with user device 105 and database 120 via cloud 115. Further detail regarding the operation of image processing apparatus 110 is provided with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

According to some aspects, database 120 stores training data (or training set) including high-quality training images. In some cases, database 120 stores high-quality real images depicting the person depicted in a low-quality image. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for generating a restored image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 2, a user (e.g., the user described with reference to FIG. 1) provides a low-quality input image depicting a person to an image processing apparatus (e.g., the image processing apparatus described with reference to FIGS. 1 and 6). In some cases, for example, the low-quality input image is a blurry image, in which the details are not clearly defined and the person (or objects) appears to be fuzzy or distorted. In response, the image processing apparatus generates a restored image having defined edges and clean details of the person depicted in the blurry image.

In some cases, additional real images are provided to the image processing apparatus as anchor images. For example, the additional real images are high-quality images (such as profile pictures or selfies) depicting the person. By using the additional real images, the image processing apparatus generates a restored image in which the identity of the person depicted in the restored image is preserved. For example, the accuracy and integrity of the visual representation of the person depicted from the low-quality input image is preserved in the high-quality output image (e.g., the restored image).

At operation 205, the user provides an input image. In some cases, the operations of this step refer to, or may be performed by, a user as described with reference to FIG. 1. For example, the user provides a low-quality image depicting a person to the image processing apparatus via a user interface on a user device (e.g., the user device described with reference to FIG. 1). In some cases, the user provides additional real images (such as profiled pictures or selfies) of the person to the image processing apparatus.

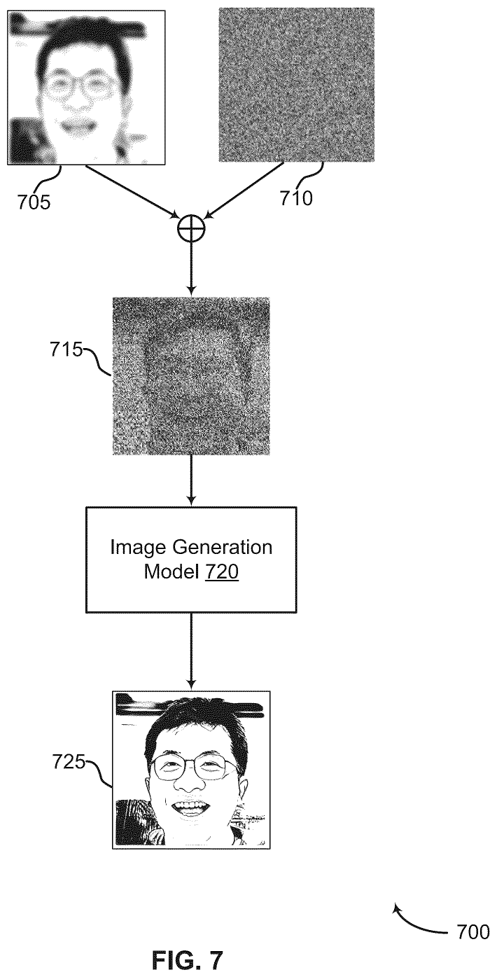

At operation 210, the system combines the input image with noise to obtain a noisy image. In some cases, the operations of this step refer to, or may be performed by, an image processing apparatus as described with reference to FIGS. 1 and 6. In some cases, the operations of this step refer to, or may be performed by, a machine learning model as described with reference to FIGS. 6 and 7. In some cases, for example, the noise is a Gaussian noise. In some cases, the noise is represented in a noise map. For example, the machine learning model is trained to perform a reverse diffusion process on the noisy image to generate an output image. In some cases, the noisy image includes features or contents of the input image. By initiating the diffusion process from the noisy image rather than pure noise, the visual features of the output image are similar to the visual features of the input image.

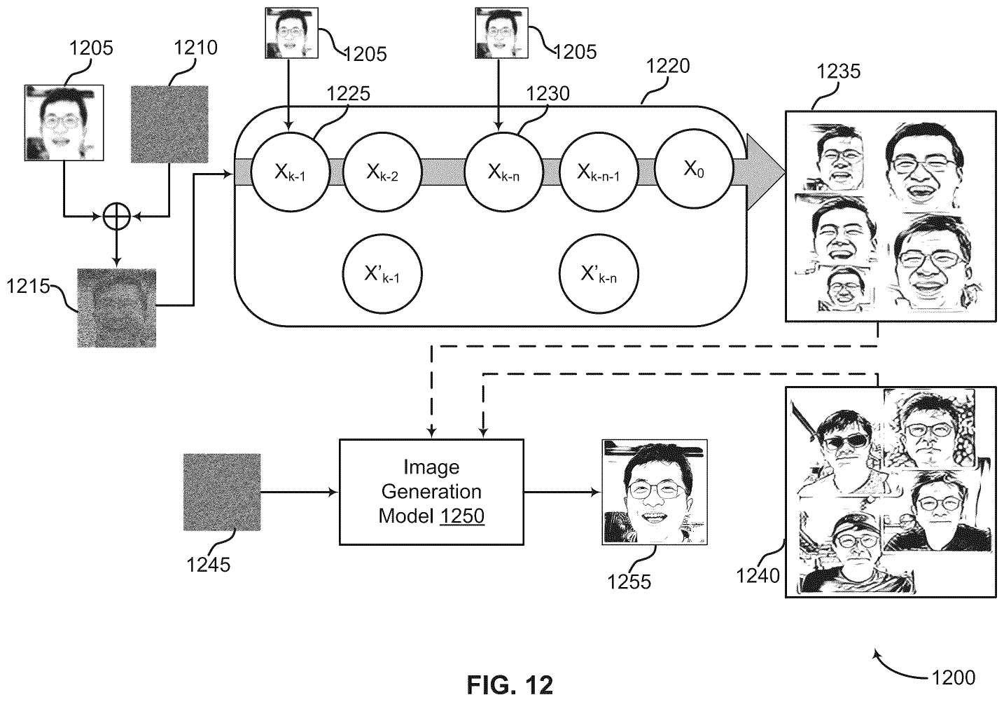

At operation 215, the system generates a restored image based on the noisy image. In some cases, the operations of this step refer to, or may be performed by, an image processing apparatus as described with reference to FIGS. 1 and 6. In some cases, the operations of this step refer to, or may be performed by, an image generation model as described with reference to FIGS. 3, 4, 6, 7, and 12. In some aspects, the image generation model is trained to generate a high-quality image based on a low-quality image. In some cases, the image generation model is trained to preserve visual features from the input image in the restored image. For example, the image generation model receives the additional real images and uses the real images as anchor images. The image generation model is fine-tuned based on the additional real images. As a result, the identity of the person depicted in the restored image is preserved. In some cases, the image processing apparatus generates a set of synthetic high-quality images as the anchor image using a skip-guidance method (described with reference to FIG. 12). The image generation model is fine-tuned based on the set of synthetic high-quality images. As a result, visual features from the low-quality input image can be preserved in the high-quality restored image.

At operation 220, the system displays the restored image. In some cases, the operations of this step refer to, or may be performed by, an image processing apparatus as described with reference to FIGS. 1 and 6. In some cases, the restored image is displayed on a user interface via a user device. In some cases, the restored image preserves an identity of the person depicted in the low-quality input image. In some cases, the restored image has a higher image quality than the input image. For example, the restored image has high resolutions, fine details, clean edges, or a combination thereof.

FIG. 3 shows an example of single-image restoration according to aspects of the present disclosure. The example shown includes image restoration system 300, input image 305, image generation model 310, synthetic images 315, restored image 320, and conventional output image 325. In some embodiments, image restoration system 300 is implemented in a user interface, where a user can provide inputs such as input image 305 to the user interface to generate restored image 320.

Referring to FIG. 3, image generation model 310 receives input image 305 depicting the face of a baby to generate restored image 320 depicting the face of the baby in high image quality. For example, input image 305 is a low-quality image depicting a baby's face. Input image 305 is blurry such that visual details are fuzzy and out of focus. In some cases, for example, input image 305 has low resolutions, which results in a lack of detail or sharpness. To preserve some visual features (e.g., identity or facial features) from input image 305, image generation model 310 generates synthetic images 315 based on input image 305 using a skip-guidance method. For example, during the image generation process (e.g., diffusion process), input image 305 is used as a guidance image in selected timesteps of the diffusion process to loosely guide the generation of synthetic images 315. In some cases, a timestep (or diffusion timestep) may be one of the discrete points in the sequence of steps in a forward diffusion process or a reverse diffusion process. During a timestep, noise is either added (during forward diffusion timestep) or removed (during reverse diffusion timestep). Further detail on the timestep is described with reference to FIG. 7.

In some cases, synthetic images 315 includes a set of various generated images that depict the baby from input image 305. For example, synthetic images 315 depicts the baby in different expressions. In some cases, each baby depicted in synthetic images 315 has the same facial features (e.g., eyes, nose, mouth, ears, hair, and skin). Further detail on the skip-guidance method is described with reference to FIG. 12.

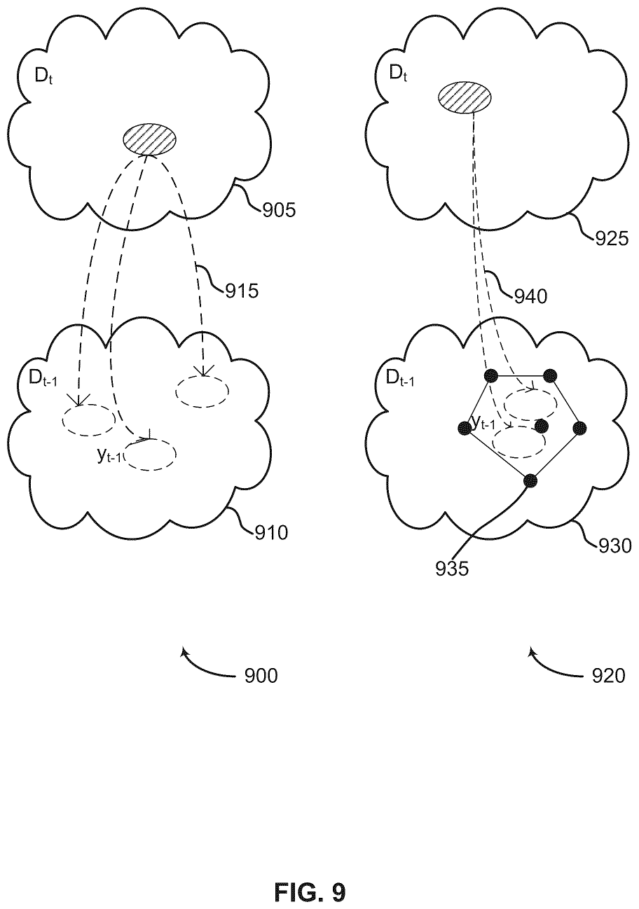

In an embodiment, synthetic images 315 are used to fine-tune the image generation model 310. For example, synthetic images 315 are used as anchor images to constrain a generative space of image generation model 310. As a result, the path of image generation becomes more constrained towards a region in the generative space constrained by the anchor images. Accordingly, image generation model 310 can generate restored image 320 without guidance. In addition, restored image 320 includes facial features from synthetic images 315. Further detail on constraining a generative space is described with reference to FIG. 9.

In some cases, conventional image generation techniques use an input image (e.g., input image 305) as guidance to an image generation model to generate conventional output image 325. For example, during the diffusion process of image generation, the input image (usually a low-quality image) is used as true guidance, where the model follows the guidance as much as possible. As a result, the image quality of the generated image is decreased, since the guidance includes low-quality features. As shown in FIG. 3, conventional output image 325 has lower image quality than the restored image 320 generated by image generation model 310. For example, conventional output image 325 depicts the baby with fuzzy edges and unclear facial details.

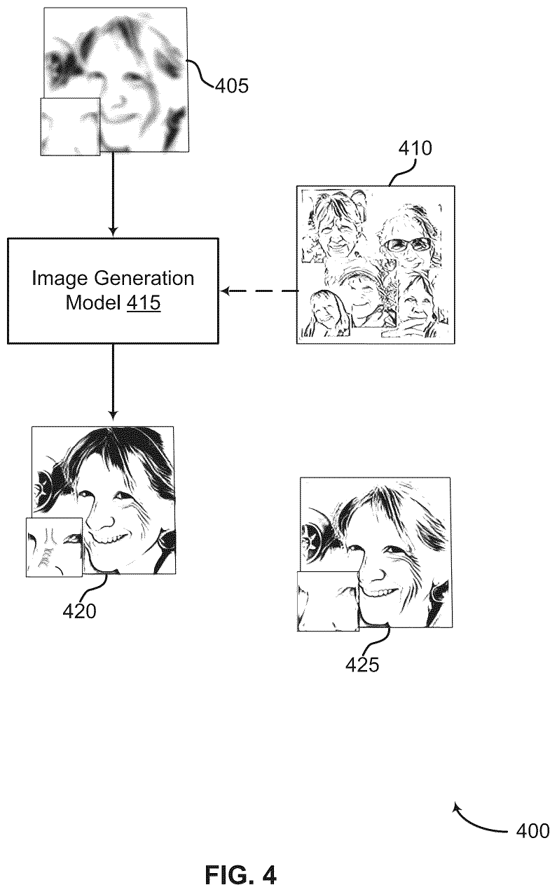

Image restoration system 300 is an example of, or includes aspects of, the corresponding element described with reference to FIG. 4. Input image 305 is an example of, or includes aspects of, the corresponding element described with reference to FIGS. 4, 7, and 12. Image generation model 310 is an example of, or includes aspects of, the corresponding element described with reference to FIGS. 4, 6, 7, and 12.

Synthetic images 315 is an example of, or includes aspects of, the corresponding element described with reference to FIG. 12. Restored image 320 is an example of, or includes aspects of, the corresponding element described with reference to FIGS. 4, 7, and 12. Conventional output image 325 is an example of, or includes aspects of, the corresponding element described with reference to FIG. 4.

FIG. 4 shows an example of image restoration using real images 410 according to aspects of the present disclosure. The example shown includes image restoration system 400, input image 405, real images 410, image generation model 415, restored image 420, and conventional output image 425. In some embodiments, image restoration system 400 is implemented in a user interface, where a user can provide inputs such as input image 405 to the user interface to generate restored image 420.

Referring to FIG. 4, image generation model 415 receives input image 405 depicting the face of an elderly woman to generate restored image 420 depicting the face of the elderly woman in high image quality. For example, input image 405 is a low-quality image depicting the face of an elderly woman. Input image 405 is blurry such that visual details are fuzzy and out of focus. In some cases, for example, input image 405 has low resolutions, which results in a lack of detail or sharpness.

In some embodiments, real images 410 are used to fine-tune the image generation model 415. In some cases, real images 410 are provided by a user. In some cases, real images 410 are profile pictures or selfies of the person depicted in input image 405. For example, real images 410 are used as anchor images to constrain a generative space of image generation model 415. As a result, the path of image generation becomes more constrained towards a region in the generative space constrained by the anchor images. Accordingly, image generation model 415 can generate restored image 420 without additional guidance based on the constrained generative space. In addition, since image generation model 415 is fine-tuned based on real images 410, image generation model 415 can generate restored image 420 that includes facial features from real images 410. Accordingly, the identity of the old lady from input image 405 can be preserved in restored image 420. Further detail on constraining a generative space is described with reference to FIG. 9.

In some cases, conventional image generation techniques do not generate an output image that preserves the identity of the old lady depicted from input image 405. For example, as shown in FIG. 4, conventional output image 425 depicts a younger lady than the lady depicted in real images 410 and the lady in input image 405. For example, conventional output image 425 depicts the lady in the absence of wrinkles on the face. However, real images 410 depicts the lady with wrinkles. Accordingly, by fine-tuning image generation model 415 using real images 410, image generation model 415 is able to generate restored image 420 that preserves the identity of the old lady depicted in input image 405.

Image restoration system 400 is an example of, or includes aspects of, the corresponding element described with reference to FIG. 3. Input image 405 is an example of, or includes aspects of, the corresponding element described with reference to FIGS. 3, 7, and 12. Real images 410 is an example of, or includes aspects of, the corresponding element described with reference to FIG. 12.

Image generation model 415 is an example of, or includes aspects of, the corresponding element described with reference to FIGS. 3, 6, 7, and 12. Restored image 420 is an example of, or includes aspects of, the corresponding element described with reference to FIGS. 3, 7, and 12. Conventional output image 425 is an example of, or includes aspects of, the corresponding element described with reference to FIG. 3.

FIG. 5 shows an example of a method 500 for generating a restored image based on an input image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 5, the system (e.g., image processing apparatus described with reference to FIGS. 1 and 6) generates a restored image based on an input image having a low image quality. In some embodiments, the input image is a blurry image having fuzzy edges and unclear details. In some embodiments, an image generation model is fine-tuned based on a plurality of images (e.g., real images or generative images), where the generative space of the image generation model is constrained based on the plurality of images. Accordingly, the image generation model is able to generate a high-quality restored image that preserves features (e.g., facial features or identity) from the low-quality input image.

At operation 505, the system obtains an input image depicting an entity and having a first quality level. In some cases, the operations of this step refer to, or may be performed by, an image generation model as described with reference to FIGS. 3, 4, 6, 7, and 12. In some cases, a user provides the input image to the image generation model, for example, via a user interface (as described with reference to FIG. 1). In some cases, the input image is a low-quality image including a blurred image, pixelated image, low-resolution image, distorted image, etc. In some cases, the input image may include artifacts or occluded regions. In some cases, an entity includes a person, an object, or a scene.

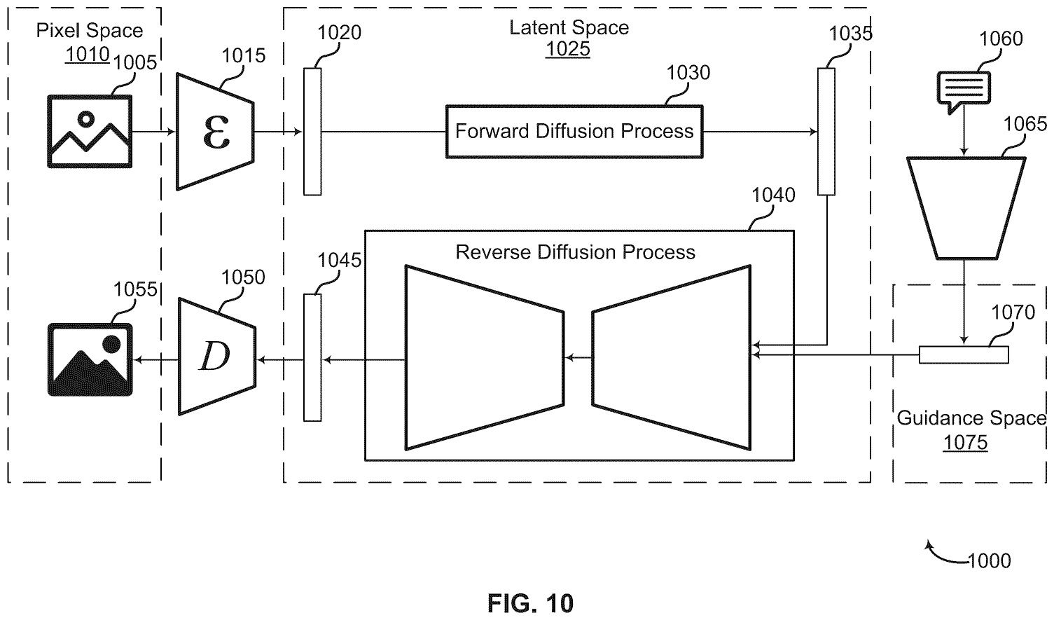

At operation 510, the system adds noise to the input image based on the first quality level to obtain an intermediate noise image. In some cases, the operations of this step refer to, or may be performed by, an image generation model as described with reference to FIGS. 3, 4, 6, 7, and 12. In some embodiments, the image generation model includes a diffusion model that takes a low-quality image as input and generates a high-quality output image, where the high-quality output image includes enhanced sharpness and clarity of the visual features depicted in the low-quality input image. In some cases, the diffusion model adds noise to the low-quality input image during the forward diffusion process to obtain a noisy image. In some cases, the diffusion model performs a reverse diffusion process by iteratively removing noise from a noise input (or the noisy image) to gradually obtain a clean image. In some cases, the diffusion process may refer to the reverse diffusion process described with reference to FIG. 10. Further detail on the forward diffusion process is described with reference to FIG. 10.

For example, during the diffusion process, the diffusion model may begin the process from pure noise (e.g., Gaussian noise). Then, the diffusion model iteratively removes noise to obtain a noisy image, where the noisy image includes noise and visual features to be generated in the output image. The process is repeated until the noise is completely removed from the noisy image to obtain a clean image (e.g., an output image). In some embodiments, by selecting an intermediate timestep, the diffusion process begins from a noisy image (instead of pure noise). Accordingly, the time required for generating an output image can be reduced.

At operation 515, the system generates a restored image depicting the entity by denoising the intermediate noise image, where the restored image has a second quality level higher than the first quality level. In some cases, the operations of this step refer to, or may be performed by, an image generation model as described with reference to FIGS. 3, 4, 6, 7, and 12. For example, the restored image is a high-quality image having sharp edges and clear visual features. In some cases, the restored image has a higher resolution or enhanced detail. In some cases, the image generation model removes blur or artifacts from the input image to generate the restored image. In some cases, the image generation model inpaints an occluded region in the input image to generate the restored image.

In some cases, visual features from the input image are maintained in the restored image. For example, the restored image maintains facial features of the person from the input image. For example, the restored image preserves an identity of the person from the input image. In some cases, the image generation model is trained using high-quality images.

### System Architecture

In FIGS. 1, 6-10, and 14, an apparatus and system for image processing include at least one processor, at least one memory storing instructions executable by the at least one processor, and an image generation model comprising parameters stored in the at least one memory and trained to generate a restored image based on an input image depicting an entity, wherein the input image is combined with a noise input to obtain a noisy image, wherein the restored image is generated based on the noisy image, and wherein the image generation model is trained using a training image depicting the entity.

In some aspects, the image generation model comprises a diffusion model. In some aspects, the image generation model comprises a U-Net architecture. Some examples of the apparatus and system further include an output space of the image generation model is constrained to images depicting the entity based on the training.

FIG. 6 shows an example of an image processing apparatus 600 according to aspects of the present disclosure. The example shown includes image processing apparatus 600, processor unit 605, I/O module 610, memory unit 615, and training component 630. In one aspect, memory unit 615 includes machine learning model 620 and image generation model 625.

According to some embodiments of the present disclosure, image processing apparatus 600 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 600 is an example of, or includes aspects of, the corresponding element described with reference to FIG. 1. Image processing apparatus 600 is an example of, or includes aspects of, the corresponding element described with reference to FIG. 1.

Processor unit 605 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 605 is configured to operate a memory array using a memory controller. In other cases, a memory controller is integrated into the processor. In some cases, processor unit 605 is configured to execute computer-readable instructions stored in a memory to perform various functions. In some embodiments, processor unit 605 includes special-purpose components for modem processing, baseband processing, digital signal processing, or transmission processing. Processor unit 605 is an example of, or includes aspects of, the processor described with reference to FIG. 14.

I/O module 610 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 610 includes a user interface. A user interface may enable a user to interact with a device. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. The user interface is an example of, or includes aspects of, the corresponding element described with reference to FIG. 14.

Examples of memory unit 615 include random access memory (RAM), read-only memory (ROM), or a hard disk. Examples of memory unit 615 include solid-state memory and a hard disk drive. In some examples, memory unit 615 is used to store computer-readable, computer-executable software including instructions that, when executed, cause a processor to perform various functions described herein.

In some cases, memory unit 615 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 615 store information in the form of a logical state.

In one aspect, memory unit 615 includes machine learning model 620 and image generation model 625. In one aspect, memory unit 615 stores instructions executable by processor unit 605. Memory unit 615 is an example of, or includes aspects of, the memory subsystem described with reference to FIG. 14.

In one aspect, machine learning model 620 includes image generation model 625. In some cases, machine learning model 620 is a computational algorithm, model, or system designed to recognize patterns, make predictions, or perform a specific task (for example, image processing) without being explicitly programmed.

According to some embodiments of the present disclosure, machine learning model 620 includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, machine learning model 620 includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model 620 includes machine learning parameters. Machine learning parameters, also known as model parameters or weights, are variables that provide a behavior and characteristics of machine learning model 620. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow machine learning model 620 to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, machine learning model 620 includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

In some cases, machine learning model 620 includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, that allows an ANN to focus on different parts of an input sequence when making predictions or generating output.

Some sequence models (such as RNAs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

The term “self-attention” refers to a machine learning model in which representations of the input interact with each other to determine attention weights for the input. Self-attention can be distinguished from other attention models because the attention weights are determined at least in part by the input itself.

According to some aspects, machine learning model 620 combines the input image and a noise input to obtain a noisy image, where an amount of the noise input is based on the selected timestep. In some aspects, the restored image preserves an identity of the entity from the input image. In some aspects, the restored image has a higher image quality than the input image.

According to some aspects, machine learning model 620 generates a noisy image and guidance information based on the training image. In some examples, machine learning model 620 obtains a real image of the entity other than the input image. Machine learning model 620 is an example of, or includes aspects of, the corresponding element described with reference to FIG. 7.

According to some aspects, image generation model 625 is implemented as software stored in memory unit 615 and executable by processor unit 605, as firmware, as one or more hardware circuits, or as a combination thereof. According to some aspects, image generation model 625 obtains an input image depicting an entity. In some examples, image generation model 625 selects an intermediate timestep. In some examples, image generation model 625 generates a restored image depicting the entity based on the intermediate timestep, where the image generation model 625 is trained using at least one training image depicting the entity.

In some examples, image generation model 625 iteratively removes noise from the noisy image based on the selected timestep. In some aspects, the intermediate timestep is based on a quality of the input image. In some examples, image generation model 625 performs a diffusion process. In some aspects, the restored image is generated without providing an image as guidance to an intermediate stage of the image generation model 625. In some examples, image generation model 625 generates a synthetic image depicting the entity, where the image generation model 625 is trained based on the synthetic image.

According to some aspects, image generation model 625 generates a noise prediction based on the noisy image. In some aspects, the noise prediction is generated based on the guidance information. In some examples, image generation model 625 performs a diffusion process at a first timestep using the guidance information. In some examples, image generation model 625 performs a diffusion process at a second timestep without the guidance information.

According to some aspects, image generation model 625 comprises parameters stored in the at least one memory and trained to generate a restored image based on an input image depicting an entity, where the input image is combined with a noise input to obtain a noisy image, where the restored image is generated based on the noisy image, and wherein the image generation model 625 is trained using a training image depicting the entity.

In some aspects, the image generation model 625 includes a diffusion model. In some aspects, the image generation model 625 includes a U-Net architecture. In some examples, image generation model 625 is constrained to images depicting the entity based on the training. Image generation model 625 is an example of, or includes aspects of, the corresponding element described with reference to FIGS. 3, 4, 7, and 12. Image generation model 625 is an example of, or includes aspects of, the diffusion model described with reference to FIG. 10.

According to some aspects, training component 630 is implemented as software stored in memory unit 615 and executable by processor unit 605, as firmware, as one or more hardware circuits, or as a combination thereof. According to some embodiments, training component 630 is implemented as software stored in a memory unit and executable by a processor in the processor unit of a separate computing device, as firmware in the separate computing device, as one or more hardware circuits of the separate computing device, or as a combination thereof. In some examples, training component 630 is part of another apparatus other than image processing apparatus 600 and communicates with the image processing apparatus 600. In some examples, training component 630 is part of image processing apparatus 600.

According to some aspects, training component 630 obtains a training set including a training image depicting an entity. In some examples, training component 630 trains an image generation model 625 to generate a restored image depicting the entity based on an input image depicting the entity, where the image generation model 625 is trained using the noisy image, the training image, and the guidance information.

In some examples, training component 630 generates the training image based on the input image. In some examples, training component 630 initializes the image generation model 625 based on a pre-trained image generation model. In some examples, training component 630 computes a diffusion loss based on the noise prediction and the training image. In some examples, training component 630 updates parameters of the image generation model 625 based on the diffusion loss.

FIG. 7 shows an example of a machine learning model according to aspects of the present disclosure. The example shown includes machine learning model 700, input image 705, noise input 710, noisy image 715, image generation model 720, and restored image 725.

Referring to FIG. 7, image generation model 720 receives input image 705 to generate restored image 725. For example, input image 705 is a low-quality image depicting a man with eyeglasses. Input image 705 is blurry, where the visual appearance of the image detail is fuzzy and unclear. In some embodiments, input image 705 and noise input 710 are added to obtain noisy image 715. In some cases, noise input 710 is random Gaussian noise. In some cases, the noise in noise input 710 follows the Gaussian distribution. In some cases, noise input 710 is represented in a form of a noise map. In some cases, noisy image 715 includes visual features from input image 705.

According to some embodiments, image generation model 720 generates restored image 725 based on noisy image 715. For example, image generation model 720 performs a diffusion process (e.g., reverse diffusion process described with reference to FIG. 10) that begins from noisy image 715. A conventional diffusion process begins from pure noise and gradually removes noise to obtain an output image. However, by doing so, conventional image generation model might not be able to generate an output image having features depicted in the input image 705. For example, the output image might not include facial features depicted in input image 705. On the contrary, image generation model 720 begins the diffusion process at an intermediate timestep using noisy image 715. In one aspect, noisy image 715 includes the facial features of the man depicted in input image 705.

Accordingly, restored image 725 may preserve the facial features from input image 705. In addition, image generation model 720 can perform fewer diffusion steps (e.g., 50 diffusion steps) to obtain restored image 725, whereas the conventional image generation model may perform 100 diffusion steps to obtain an output image because the conventional image generation model begins the diffusion process from pure noise. In some cases, restored image 725 has a higher image quality than input image 705. For example, restored image 725 may have higher resolutions, finer edges, clearer or enhanced details, and/or fewer artifacts than input image 705. In some cases, image generation model 720 may inpaint an occluded region of input image 705.

In some embodiments, a machine learning model of the present disclosure selects a diffusion timestep based on the quality of input image 705. For example, if input image 705 includes substantial degradation (such as blurriness, lack of resolution, heavy pixelation, or distortion), the amount of diffusion timestep may be large (e.g., 80 diffusion timesteps). For example, if input image 705 includes less degradation, the amount of diffusion timestep may be small (e.g., 20 diffusion timesteps).

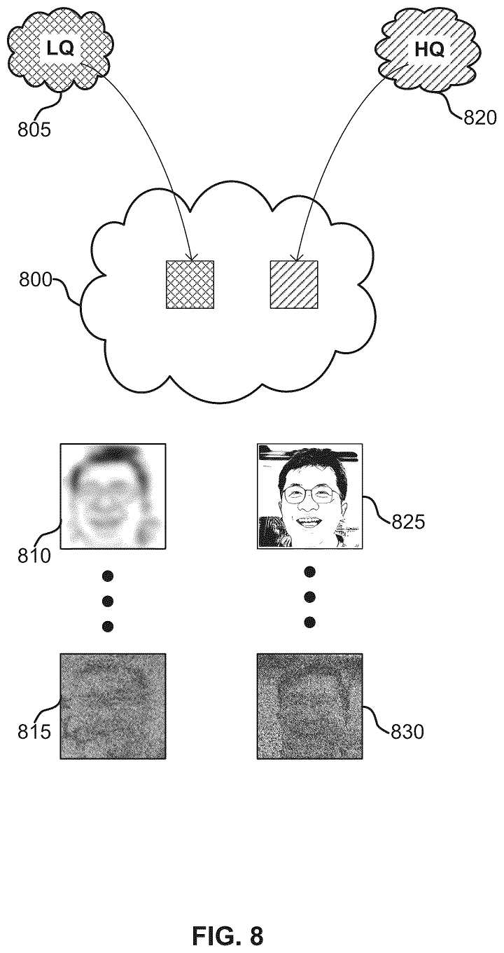

According to some embodiments, to exploit the generative capacity of the diffusion model, the iterative sampling process for restoration is used. For example, when sufficient Gaussian noise is added to the input image y₀, the resultant image yₜ (e.g., restored image 725) can be represented as:

$${y}_{t} = \sqrt{{α}_{t}} {y}_{0} + \sqrt{1 - {α}_{t}} ϵ , where ϵ \sim N ( 0 , I ) \qquad ( 1 )$$

where the resultant image yₜ becomes indistinguishable from the underlying clean image x₀ with the same noise. For example, a noise step, or timestep, K is selected such that:

$${y}_{K} \approx {x}_{K} \qquad ( 2 )$$

where as α decreases and same noise ∈ is sampled. As shown in FIG. 8, adding noise to high-quality and low-quality images brings the images to the same distribution. As a result,

$$p ( {x}_{0} \vert {y}_{K} ) \approx p ( {x}_{0} \vert {x}_{K} ) \qquad ( 3 )$$

Accordingly, the image generation model 720 can sample a clean image x₀ from p(x₀|y_{K}) using the same sampling process as from p(x₀|x_{K}), where p(x₀|x_{K}) may represent the sampling process of a pre-trained diffusion model. Accordingly, the resultant image (e.g., restored image 725) matches the quality of the images generated from the pre-trained diffusion model. The forward and reverse diffusion processes are further described with reference to FIG. 10.

In some embodiments, a diffusion timestep K is selected, which determines the amount of noise added to the low-quality input image to begin the sampling process. In some cases, for example, diffusion timestep K is selected to be 200, 400, or 600. As the diffusion timestep increases, the quality of restored image 725 increases. In some cases, image generation model 720 generates high-quality images while reducing the information loss from input image 705.

Machine learning model 700 is an example of, or includes aspects of, the corresponding element described with reference to FIG. 6. Input image 705 is an example of, or includes aspects of, the corresponding element described with reference to FIGS. 3, 4, and 12. Noise input 710 is an example of, or includes aspects of, the corresponding element described with reference to FIG. 12.

Noisy image 715 is an example of, or includes aspects of, the corresponding element described with reference to FIG. 12. Image generation model 720 is an example of, or includes aspects of, the corresponding element described with reference to FIGS. 3, 4, 6, and 12. Restored image 725 is an example of, or includes aspects of, the corresponding element described with reference to FIGS. 3, 4, and 12.

FIG. 8 shows an example of image projection in image restoration according to aspects of the present disclosure. The example shown includes generative space 800, low-quality image space 805, low-quality image 810, low-quality noisy image 815, high-quality image space 820, high-quality image 825, and high-quality noisy image 830.

Referring to FIG. 8, the input image is projected into generative space 800 of the image generation model (as described with reference to FIGS. 3, 4, 6, 7, and 12). For example, the image generation model is trained on high-quality images, whereas conventional models are trained on image pairs of low-quality image and high-quality image. To utilize the generative space of a pre-trained image generation model, image projection is used. For example, generative space 800 includes low-quality image space 805 and high-quality image space 820. To map a low-quality image 810 and a high-quality image 825 into the generative space, Gaussian noise is added. For example, Gaussian noise is added to low-quality image 810 to obtain low-quality noisy image 815. Similarly, Gaussian noise is added to high-quality image 825 to obtain high-quality noisy image 830. As a result, the distribution of low-quality noisy image 815 and high-quality noisy image 830 is matched.

In some embodiments, the image generation model includes a diffusion model that approximates the training image distribution p_{θ}(x₀) by learning a model θ that effectively reverses the process of adding noise. For example, the diffusion model gradually adds Gaussian nose into a clean image x₀ such that:

$${x}_{t} = \sqrt{{α}_{t}} {y}_{0} + \sqrt{1 - {α}_{t}} ϵ , where ϵ \sim N ( 0 , I ) . \qquad ( 4 )$$

The reverse generative process progressively denoises (or removes noise) noisy image xₜ until noisy image xₜ is free from noise. When the diffusion model is trained, for any given time t and the corresponding noisy image xₜ, the diffusion model can iteratively denoise by sampling from p(x₀|xₜ). In the field of image restoration, the diffusion model recovers the latent high-quality image x₀ from a low-quality image y₀. Embodiments of the present disclosure recover the high-quality image by sampling from the posterior:

$$\hat{x} \sim p ( {x}_{0} \vert {y}_{0} ) . \qquad ( 5 )$$

FIG. 9 shows an example of generative space constraining of an image generation model according to aspects of the present disclosure. The example shown includes unconstrained generation 900, first generative space 905, second generative space 910, unconstrained path 915, constrained generation 920, third generative space 925, fourth generative space 930, and constrained path 940. In one aspect, fourth generative space 930 includes anchor 935.

Referring to FIG. 9, unconstrained generation 900 and constrained generation 920 are described. In unconstrained generation 900, the generative path of a noisy image yₜ from first generative space 905 to second generative space 910 via unconstrained path 915 is arbitrary. For example, when a generative space of an image generation model is not constrained, the output image may land at any location in the generative space, where each image generation may become inconsistent. For example, the first image generation may result in an image depicting a rose, and the second image generation may result in an image depicting a sunflower.

On the contrary, in constrained generation 920, generative path of a noisy image yₜ from third generative space 925 to fourth generative space 930 via constrained path 940 is constrained towards the region represented by anchor 935. For example, anchor 935 includes anchor images, where anchor images are images (e.g., the one or more real images or the one or more synthetically generated images described with reference to FIG. 12) used to fine-tune the image generation model. As a result, each image generation is more consistent. For example, if the anchor images depict different images of a sunflower, then each image generation results in an image depicting a sunflower.

In some cases, the loss of information is inherent in the diffusion process. Due to the stochasticity of the forward diffusion process, the clean image generation using the reverse diffusion process from noisy image xₜ might not match the original image x₀. For example, the larger the t (e.g., the diffusion timestep to iteratively add or remove the noise), the larger the generative space p(x₀|xₜ). In some cases, due to the large generative space, image restoration might not be ideal because input content (e.g., visual features from the input image) needs to be preserved. To resolve the aforementioned issue, embodiments of the present disclosure constrain the generative space of the image generation model to a subspace that tightly surrounds the underlying clean images. For example, a set of anchor images is used to fine-tune the diffusion model to constrain the generative space. In some cases, the set of anchor images is obtained from a personal album or a generative album. For example, the personal album includes images, selfies, and profile pictures of the person depicted in the input image. In some cases where a personal album is absent, the image generation model generates a plurality of images based on the input image using a skip guidance method (described with reference to FIG. 12) as anchor images.

FIG. 10 shows an example of an image generation model according to aspects of the present disclosure. The example shown includes diffusion model 1000, original image 1005, pixel space 1010, image encoder 1015, original image feature 1020, latent space 1025, forward diffusion process 1030, noisy feature 1035, reverse diffusion process 1040, denoised image feature 1045, image decoder 1050, output image 1055, text prompt 1060, text encoder 1065, guidance feature 1070, and guidance space 1075.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (e.g., latent diffusion).

Diffusion models work by iteratively adding noise to the data during a forward process and then learning to recover the data by denoising the data during a reverse process. For example, during training, diffusion model 1000 may take an original image 1005 in a pixel space 1010 as input and apply an image encoder 1015 to convert original image 1005 into original image features 1020 in a latent space 1025. Then, a forward diffusion process 1030 gradually adds noise to the original image features 1020 to obtain noisy features 1035 (also in latent space 1025) at various noise levels.

Next, a reverse diffusion process 1040 (e.g., a U-Net ANN) gradually removes the noise from the noisy features 1035 at the various noise levels to obtain the denoised image feature 1045 in latent space 1025. In some examples, denoised image feature 1045 is compared to the original image feature 1020 at each of the various noise levels, and parameters of the reverse diffusion process 1040 of the diffusion model are updated based on the comparison. Finally, an image decoder 1050 decodes the denoised image feature 1045 to obtain an output image 1055 in pixel space 1010. In some cases, an output image 1055 is created at each of the various noise levels. The output image 1055 can be compared to the original image 1005 to train the reverse diffusion process 1040. In some cases, output image 1055 refers to the restored image (e.g., described with reference to FIGS. 3, 4, 7, and 12).

In some cases, image encoder 1015 and image decoder 1050 are pre-trained prior to training the reverse diffusion process 1040. In some examples, image encoder 1015 and image decoder 1050 are trained jointly, or the image encoder 1015 and image decoder 1050 are fine-tuned jointly with the reverse diffusion process 1040.

The reverse diffusion process 1040 can also be guided based on a text prompt 1060, or another guidance prompt, such as an image, a layout, a style, a color, a segmentation map, etc. The text prompt 1060 can be encoded using a text encoder 1065 (e.g., a multimodal encoder) to obtain guidance features 1070 in guidance space 1075. The guidance features 1070 can be combined with the noisy features 1035 at one or more layers of the reverse diffusion process 1040 to ensure that the output image 1055 includes content described by the text prompt 1060. For example, guidance feature 1070 can be combined with the noisy feature 1035 using a cross-attention block within the reverse diffusion process 1040.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring a similarity between each query representation and the key representations, where a higher similarity indicates that more attention is given to a key element. An attention score indicates an importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing the machine learning model to understand the context and generate more accurate and contextually relevant outputs.

In some examples, diffusion models are based on a neural network architecture known as a U-Net. The U-Net takes input features having an initial resolution and an initial number of channels, and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt (e.g., text prompt 1060) describing content to be included in a generated image. In some examples, guidance can be provided in a form other than text, such as via an image, a sketch, a color, a style, or a layout. The system converts text prompt 1060 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 1000 generates an image based on the noise map and the conditional guidance vector.

A diffusion process can include both a forward diffusion process 1030 for adding noise to an image (e.g., original image 1005) or features (e.g., original image feature 1020) in a latent space 1025 and a reverse diffusion process 1040 for denoising the images (or features) to obtain a denoised image (e.g., output image 1055). The forward diffusion process 1030 can be represented as q(xₜ|xₜ−1), and the reverse diffusion process 1040 can be represented as p(xₜ₋₁|xₜ). In some cases, the forward diffusion process 1030 is used during training to generate images with successively greater noise, and a neural network is trained to perform the reverse diffusion process 1040 (e.g., to successively remove the noise).

In an example forward diffusion process 1030 for a latent diffusion model (e.g., diffusion model 1000), the diffusion model 1000 maps an observed variable x₀ (either in a pixel space 1010 or a latent space 1025) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse diffusion process 1040. During the reverse diffusion process 1040, the diffusion model 1000 begins with noisy data x_{T}, such as a noisy image and denoises the data to obtain the p(xₜ₋₁|xₜ). At each step t−1, the reverse diffusion process 1040 takes xₜ, such as the first intermediate image, and t as input. Here, t represents a step, or timestep, in the sequence of transitions associated with different noise levels, The reverse diffusion process 1040 outputs xₜ₋₁, such as the second intermediate image iteratively until x_{T} is reverted back to x₀, the original image 1005. The reverse diffusion process 1040 can be represented as:

$${p}_{θ} ( {x}_{t - 1} \vert {x}_{t} ) := N ( {x}_{t - 1} ; {μ}_{θ} ( {x}_{t} , t ) , {Σ}_{θ} ( {x}_{t} , t ) ) . \qquad ( 6 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 7 )$$

where p(x_{T})=N(x_{T};0,l) is the pure noise distribution as the reverse diffusion process 1040 takes the outcome of the forward diffusion process 1030, a sample of pure noise, as input and Πₜ₌₁^{T}p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space 1025 as input and a generated data \tilde{x} is mapped back into the pixel space 1010 from the latent space 1025 as output. In some examples, x₀ represents an original input image with low image quality, latent variables x₁, . . . , x_{T} represent noisy images, and \tilde{x} represents the generated image with high image quality.

A diffusion model 1000 may be trained using both a forward diffusion process 1030 and a reverse diffusion process 1040. In one example, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 1030 in N stages. In some cases, the forward diffusion process 1030 is a fixed process where Gaussian noise is successively added to an image. In latent diffusion models, the Gaussian noise may be successively added to features (e.g., original image features 1020) in a latent space 1025.

At each stage n, starting with stage N, a reverse diffusion process 1040 is used to predict the image or image features at stage n−1. For example, the reverse diffusion process 1040 can predict the noise that was added by the forward diffusion process 1030, and the predicted noise can be removed from the image to obtain the predicted image. In some cases, an original image 1005 is predicted at each stage of the training process.

The training component (e.g., training component described with reference to FIG. 6) compares predicted image (or image features) at stage n−1 to an actual image (or image features), such as the image at stage n−1 or the original input image. For example, given observed data x, the diffusion model 1000 may be trained to minimize the variational upper bound of the negative log-likelihood −log p_{θ}(x) of the training data. The training component then updates parameters of the diffusion model 1000 based on the comparison. For example, parameters of a U-Net may be updated using gradient descent. Time-dependent parameters of the Gaussian transitions can also be learned.

### Training and Evaluation

In FIGS. 11-13, a method, apparatus, non-transitory computer readable medium, and system for image processing include obtaining a training set including a training image depicting an entity, generating a noisy image and guidance information based on the training image, and training an image generation model to generate a restored image depicting the entity based on an input image depicting the entity, where the image generation model is trained using the noisy image, the training image, and the guidance information.

Some examples of the method, apparatus, non-transitory computer readable medium, and system further include generating the training image based on the input image. Some examples of the method, apparatus, non-transitory computer readable medium, and system further include obtaining a real image of the entity other than the input image. Some examples of the method, apparatus, non-transitory computer readable medium, and system further include initializing the image generation model based on a pre-trained image generation model.

Some examples of the method, apparatus, non-transitory computer readable medium, and system further include generating a noise prediction based on the noisy image. Some examples further include computing a diffusion loss based on the noise prediction and the training image. Some examples further include updating parameters of the image generation model based on the diffusion loss. In some aspects, the noise prediction is generated based on the guidance information.

Some examples of the method, apparatus, non-transitory computer readable medium, and system further include performing a diffusion process at a first timestep using the guidance information. Some examples further include performing a diffusion process at a second timestep without the guidance information.

FIG. 11 shows an example of a method 1100 for training an image generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1105, the system obtains a training set including a training image depicting an entity. In some cases, the operations of this step refer to, or may be performed by, a training component as described with reference to FIG. 6. In some cases, the training image is a high-quality image depicting a person, object, or scene. For example, the high-quality image depicts the entity with well-defined edges, clean details, and/or high resolutions.

At operation 1110, the system generates a noisy image and guidance information based on the training image. In some cases, the operations of this step refer to, or may be performed by, a machine learning model as described with reference to FIGS. 6 and 7. In some cases, noise is added to the training image to obtain a noisy image. In some cases, the training image is used as guidance to loosely guide the diffusion process of the image generation model.

At operation 1115, the system trains an image generation model to generate a restored image depicting the entity based on an input image depicting the entity, where the image generation model is trained using the noisy image, the training image, and the guidance information. In some cases, the operations of this step refer to, or may be performed by, a training component as described with reference to FIG. 6. In some cases, the image generation model generates high-quality images based on a low-quality input image. Further detail on training the image generation model is described with reference to FIG. 12.

FIG. 12 shows an example of fine-tuning an image generation model according to aspects of the present disclosure. The example shown includes training system 1200, input image 1205, noise input 1210, noisy image 1215, diffusion process 1220, synthetic images 1235, real images 1240, noisy input 1245, image generation model 1250, and restored image 1255. In one aspect, diffusion process 1220 includes first time step 1225 and second time step 1230.

Referring to FIG. 12, image generation model 1250 is fine-tuned based on synthetic images 1235 or real images 1240. In one aspect, a fine-tuned image generation model 1250 may generate restored image 1255 based on noisy input 1245. In some embodiments, synthetic images 1235 or real images 1240 are used as anchor images to constrain image generation model 1250. In some cases, real images 1240 include personal images, selfies, and/or profile pictures depicting the person from input image 1205. Absent real image, image generation model 1250 generates synthetic images 1235 based on input image 1205 using a skip guidance method.

According to some aspects, the skip guidance method enables image generation model 1250 to generate a synthetic image that includes features from input image 1205 while retaining a high image quality. For example, input image 1205 and noise input are combined to obtain noisy image 1215. Noisy image used to initiate diffusion process 1220. For example, during first time step 1225, input image 1205 is used as guidance to guide diffusion process 1220. Then, input image 1205 is used as guidance to guide diffusion process 1220 during second time step 1230. In some cases, first time step 1225 and second time step 1230 are not consecutive. In some cases, during a third time step, input image 1205 is not used as guidance to guide diffusion process 1220, where the third time step is between first time step 1225 and second time step 1230. As a result, the synthetic image generated using the skip guidance method contains input information from input image 1205 while retaining high image quality.

In some embodiments, image generation model 1250 is fine-tuned based on one or more real images or one or more synthetically generated images. After fine-tuning the image generation model 1250, the generative space of image generation model 1250 is constrained. As a result, restored image 1255 is generated without using input image 1205 or another reference image as guidance. Accordingly, the process time is reduced and the high image-quality of restored image 1255 is maintained.

In some cases, image generation model 1250 is fine-tuned based on one or more real images. For example, an album of different clean images of the person depicted in input image 1205 is provided to image generation model 1250. The album includes selfies, profile pictures, etc. As a result, image generation model 1250 is able to generate high-quality images including authentic high-frequency details absent in the degraded observation. In addition, identity preservation is achieved in the restoration process.

In some cases, image generation model 1250 is fine-tuned based on one or more synthetically generated images (sometimes referred to as synthetic album) based on input image 1205. In one aspect, the generative space of image generation model 1250 is constrained to a subspace of high-quality realistic images close to the low-quality input image. In some cases, noise ∈_{K} is added to input image y₀ to obtain noisy image y_{K}. Then, noisy image y_{K} is progressively denoised using image generation model 1250 to obtain denoised image xₜ. In some cases, image generation model 1250 is a pre-trained diffusion model. Then, a diffusion loss L₁ computed based on the distance between the input image ₀ and the denoised image xₜ as follows:

$${x}_{t}^{′} = {x}_{t} - λ {∇}_{{x}_{t}} {‖ {y}_{0} - {\hat{x}}_{0 , t} ‖}_{2}^{2} \qquad ( 8 )$$

Contrary to conventional techniques where guidance is strictly followed by the diffusion model, the guidance used to generate the synthetic album is an approximation. For example, the approximated guidance, using the input image y₀, is periodically applied at every n steps (also known as skip guidance). By using the skip guidance method, generated image can loosely follow the information in the input image y₀ while retaining the quality of the images in the generative steps. The aforementioned process is repeated multiple times to obtain a set of generated images to form the synthetic album. In addition, image generation model 1250 does not make assumptions on the degradation process at training or inference.

In some embodiments, image generation model 1250 is initialized based on a pre-trained image generation model. For example, when using synthetic images 1235 as anchor images, image generation model 1250 may generate 16 images using the skip-guidance method, to form a generative album. Then, image generation model 1250 is fine-tuned using the generative album to constrain the generative space. Alternatively, image generation model 1250 is fine-tuned using real images 1240. In some cases, for example, image generation model 1250 is initialized by setting the hyper-parameters. For example, the amount of diffusion steps K is set to 200. In some cases, image generation model is fine-tuned for 3,000 iterations with a batch size of 4 and a learning rate of 1e-5.

Input image 1205 is an example of, or includes aspects of, the corresponding element described with reference to FIGS. 3, 4, and 7. Noise input 1210 is an example of, or includes aspects of, the corresponding element described with reference to FIG. 7. Noisy image 1215 is an example of, or includes aspects of, the corresponding element described with reference to FIG. 7.

Synthetic images 1235 is an example of, or includes aspects of, the corresponding element described with reference to FIG. 3. Real images 1240 is an example of, or includes aspects of, the corresponding element described with reference to FIG. 4. Image generation model 1250 is an example of, or includes aspects of, the corresponding element described with reference to FIGS. 3, 4, 6, and 7. Restored image 1255 is an example of, or includes aspects of, the corresponding element described with reference to FIGS. 3, 4, and 7.

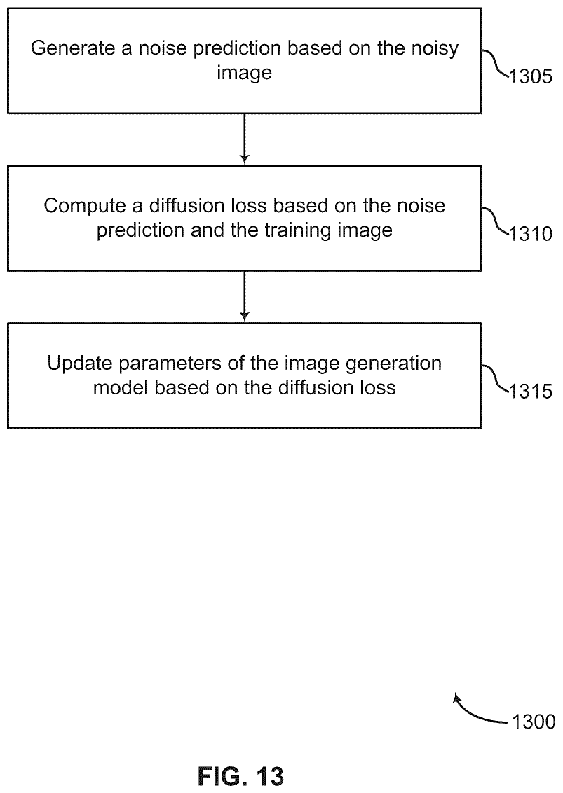

FIG. 13 shows an example of a method 1300 for training an image generation model based on a loss according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1305, the system generates a noise prediction based on the noisy image. In some cases, the operations of this step refer to, or may be performed by, an image generation model as described with reference to FIGS. 3, 4, 6, 7, and 12. For example, the image generation model generates a prediction of a noisy image that includes one or more visual features of the training image. In one aspect, the noisy image includes noise. In some cases, the restored image is generated based on the noise prediction.

At operation 1310, the system computes a diffusion loss based on the noise prediction and the training image. In some cases, the operations of this step refer to, or may be performed by, a training component as described with reference to FIG. 6. In some cases, for example, the image generation model computes the diffusion loss by calculating a distance between the noise prediction and the training image. In some cases, the diffusion loss includes a mean squared error, where the image generation model computes the mean square difference between the predicted noise and the training image. In some cases, the diffusion loss includes a mean absolute error, where the image generation model computes the mean absolute difference between the predicted noise and the training image. In some cases, the diffusion model includes a perceptual loss, where the image generation model measures the difference between high-level feature representations of the noise prediction and the training image.

At operation 1315, the system updates parameters of the image generation model based on the diffusion loss. In some cases, the operations of this step refer to, or may be performed by, a training component as described with reference to FIG. 6. In some cases, parameters of the image generation model are updated to minimize the discrepancy between the prediction (e.g., the restored image) and the ground truth image (e.g., the training data). For example, the image generation model generates the restored image based on the noise prediction.

FIG. 14 shows an example of a computing device 1400 according to aspects of the present disclosure. The example shown includes computing device 1400, processor 1405, memory subsystem 1410, communication interface 1415, I/O interface 1420, user interface component 1425, and channel 1430.

In some embodiments, computing device 1400 is an example of, or includes aspects of, the image processing apparatus described with reference to FIGS. 1 and 6. In some embodiments, computing device 1400 includes processor 1405 that can execute instructions stored in memory subsystem 1410 to obtain an input image depicting an entity, select an intermediate timestep, and generate a restored image depicting the entity based on the intermediate timestep, where an image generation model is trained using at least one training image depicting the entity.

According to some embodiments, processor 1405 includes one or more processors. In some cases, processor 1405 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1405 is configured to operate a memory array using a memory controller. In other cases, a memory controller is integrated into processor 1405. In some cases, processor 1405 is configured to execute computer-readable instructions stored in a memory to perform various functions. In some embodiments, processor 1405 includes special-purpose components for modem processing, baseband processing, digital signal processing, or transmission processing. Processor 1405 is an example of, or includes aspects of, the processor unit described with reference to FIG. 6.

According to some embodiments, memory subsystem 1410 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1410 is an example of, or includes aspects of, the memory unit described with reference to FIG. 6.

According to some embodiments, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1415.

According to some embodiments, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or hardware components controlled by the I/O controller.

According to some embodiments, user interface component 1425 enables a user to interact with computing device 1400. In some cases, user interface component 1425 includes an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over existing technology (e.g., conventional image generation models). Example experiments demonstrate that the image processing apparatus based on the present disclosure outperforms conventional image generation models. Details on the example use cases based on embodiments of the present disclosure are described with reference to FIGS. 3 and 4.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input image depicting an entity and having a first quality level;
adding noise to the input image based on the first quality level to obtain an intermediate noise image; and
generating, using an image generation model, a restored image depicting the entity by denoising the intermediate noise image, wherein the restored image has a second quality level higher than the first quality level.

2. The method of claim 1, wherein generating the restored image comprises:
selecting a timestep for the image generation model based on the first quality level, wherein the denoising is performed based on the selected timestep.

3. The method of claim 2, wherein generating the restored image comprises:
iteratively removing noise from the intermediate noise image based on the selected timestep.

4. The method of claim 2, wherein:
the selected timestep is based on the first quality level of the input image.

5. The method of claim 1, wherein:
the image generation model has a constrained latent space based on training using at least one training image depicting the entity.

6. The method of claim 1, wherein:
the restored image is generated without providing an image as guidance to an intermediate stage of the image generation model.

7. The method of claim 1, further comprising:
generating a synthetic image depicting the entity, wherein the image generation model is trained based on the synthetic image.

8. The method of claim 1, wherein:
the restored image preserves an identity of the entity from the input image.

9. The method of claim 1, wherein:
the restored image has a higher image quality than the input image.

10. A method for training a machine learning model, comprising:
obtaining a training set including a training image depicting an entity;
generating a noisy image and guidance information based on the training image; and
training an image generation model to generate a restored image depicting the entity based on an input image depicting the entity, wherein the image generation model is trained using the noisy image, the training image, and the guidance information.

11. The method of claim 10, wherein obtaining the training set comprises:
generating the training image based on the input image.

12. The method of claim 10, wherein obtaining the training set comprises:
obtaining a real image of the entity other than the input image.

13. The method of claim 10, further comprising:
initializing the image generation model based on a pre-trained image generation model.

14. The method of claim 10, wherein training the image generation model comprises:
generating a noise prediction based on the noisy image;
computing a diffusion loss based on the noise prediction and the training image; and
updating parameters of the image generation model based on the diffusion loss.

15. The method of claim 14, wherein:
the noise prediction is generated based on the guidance information.

16. The method of claim 10, wherein training the image generation model comprises:
performing a diffusion process at a first timestep using the guidance information; and
performing a diffusion process at a second timestep without the guidance information.

17. An apparatus comprising:
at least one processor;
at least one memory storing instructions executable by the at least one processor; and
an image generation model comprising parameters stored in the at least one memory and trained to generate a restored image based on an input image depicting an entity, wherein the input image is combined with a noise input to obtain a noisy image, wherein the restored image is generated based on the noisy image, and wherein the image generation model is trained using a training image depicting the entity.

18. The apparatus of claim 17, wherein:
the image generation model comprises a diffusion model.

19. The apparatus of claim 17, wherein:
the image generation model comprises a U-Net architecture.

20. The apparatus of claim 17, further comprising:
an output space of the image generation model is constrained to images depicting the entity based on the training.
